(19) United States
(12) Patent Application Publication
(10) Pub. No.: US 2008/0172849 A1
(43) Pub. Date: Jul. 24, 2008

(54) Memorial marker with a cremation URN and memorabilia container

(76) Inventor: Cynthia Gallagher, Newark, DE (US)

Correspondence Address: Cynthia Gallagher, 914 Pheasant Run, Newark, DE, 19711, US

(21) Appl. No.: 12/009,519

(22) Filed: Jan. 18, 2008

Related U.S. Application Data
(60) Provisional application No. 60/881,018, filed on Jan. 18, 2007.

(51) Int. Cl. A61G 17/08

(52) U.S. Cl. 27/1

(57) ABSTRACT

A Memorial Marker with a Cremation Urn and Memorabilia Container for humans and pets are disclosed. A memorial marker with a cremation urn and memorabilia container in accordance with the embodiment of the present invention may include an assembly of the marker coupled to an extending below cremation urn and memorabilia container being one and the same container, such that said urn and container is thereby large enough to hold human cremated remains or animal cremated remains further including a means for memorabilia type items.

### CROSS REFERENCE TO RELATED APPLICATIONS

This application claims the benefit of design patent application Ser. No. US D463,895 S, filed Oct. 1, 2002 by the present inventor, Cynthia Gallagher, also known as Cynthia Krabbe.

This application claims the benefit of a Provisional Patent Application No. 60/881,018, filed Jan. 18, 2007 by the present inventor Cynthia Gallagher with a Foreign Filing License Granted Feb. 2, 2007 with country code and number of priority application US 60/881,018.

### FEDERALLY SPONSORED RESEARCH

Not Applicable

### SEQUENCE LISTING OR PROGRAM

Not Applicable

1. Field of Invention

The present invention relates to memorial markers, urns, and memorabilia containers for memorializing a deceased individual or pet, and in particular providing a place for cremated ashes and memorabilia items.

2. Prior Art

Funeral Homes and Memorial makers commonly offer consumers an urn that holds less than 220 cubic inches. In many instances this is not large enough for the cremated ashes and/or articles of remembrance memorabilia. As a result, consumers are forced to place the remaining cremated ashes in a separate cardboard box. In addition, consumers must find another place for the remembrance memorabilia.

Originally urns were just made for cremated ashes. Yet consumers have found that they have special articles of memorabilia that they would like to bury with their loved ones cremated ashes further concluding that there is not enough room for the articles.

Since an increasing number of consumers are choosing cremation as their choice of burial, the need for a larger urn with ample space for articles of remembrance is in higher demand.

Many memorial markers do not contain a space for cremated ashes and articles of memorabilia, further they only contain the marker that lists an individuals name with their date of birth and their date of death and most recently with a picture or design.

Pet owners who have lost a pet are handed a cardboard box filled with their pet's cremated ashes after the pet was euthanized at the veterinarian's office.

Many pet memorial markers do not contain an urn for the cremated ashes or a memorabilia container for articles that they would like to bury with the cremated ashes, such as, the pet's collar, favorite toy, pictures, etc.

Although human and pet memorials have become more personalized, they do not have ample space for cremated ashes and articles of memorabilia. In most cases the consumer does not have an option to place the memorial at a place of their choice.

Consumers have a need to bury special articles with their loved ones or pets to help them heal from their loss. Consumers have a need to visit a special burial site of their choice to help them recover from their loss.

Many consumers who have had their loved ones or their pet's cremated ashes sprinkled on land or at sea, find themselves later wanting a special memorial close to home to visit. They feel as if they have thrown away the memories with the ashes.

The memorabilia container would be extremely needed at this time to aid in the healing of the individual who is mourning, as they can place those special items in the memorabilia container and choose a special design for the memorial marker.

Places of business that offer memorial markers do not offer many colorful designs. My design patent US D463,895 S, Oct. 1, 2002 holds a colorful design which can be reconfigured to fit in the 12″ diameter memorial marker space available. Yet that patent does not include other designs such as this memorial marker relates to other designs chosen by the consumer to help them heal and remember their loved one or pet in a happy way.

Memorial markers that have photographs of the loved one, does not contain an urn or memorabilia container.

Nevertheless, all the memorial markers, cremation urns, and memorabilia containers heretofore known suffer from a number of disadvantages:

a) Memorial markers do not contain an urn and memorabilia container, thereby forcing the consumer to buy these separate items and ultimately they are unable to keep the cremated ashes, memorabilia items and memorial together. In most instances, the memorial marker is in the cemetery, the cremated ashes are either in the cemetery or located somewhere in the home or scattered in the ocean, mountains, etc. and the memorabilia is scattered in different places in the home and elsewhere.

b) Most urns only hold under 220 cubic inches. This is only large enough for 99% of human cremated remains. If a consumer purchases an urn for a large person, the deceased ashes will not fit in the urn, thereby forcing the consumer to separate the cremated ashes and take a partial amount home in a cardboard box.

c) Since urns are approximately 200 to 220 cubic inches they normally do not have enough space to house memorabilia items, such as, jewelry, letters, cards, CD's, and photographs to name a few.

d) After a pet is euthanized at a veterinarian's office, they receive the cremated ashes in a cardboard box. After years of companionship, love and loyalty, the consumer needs a memorial for their pet, and a place to put the cremated ashes and memorabilia items such as, the pet's collar, favorite toy, photograph's, etc.

e) Memorial markers normally do not contain a memorabilia container but are necessary for consumers who need a memorial to visit containing special items signifying love, friendship, remembrance, to aid them in mourning and healing. Consumers who have sprinkled cremated ashes on land or sea, find a need later for a memorial marker with a memorabilia container. They feel as if they have thrown away the memory of the deceased.

f) Individuals who have loved ones buried in the Arlington National Cemetery, or other Veteran's cemeteries, also have a need to have a memorial marker in their backyard, close to home, and can place the special remembrance articles inside the memorabilia container, with a special memorial marker of their choosing to view and visit often without making a trip to the Arlington National Cemetery or other Veteran's cemeteries.

g) Pet markers do not include a memorabilia container. Many pet owners still have the cremated ashes of their pet in their home.

h) Urns are not large enough for at least 1% of the population.

i) Urns are not large enough for cremated ashes and memorabilia items.

3. Object and Advantages

Accordingly, besides the objects and advantages of the memorial marker with a cremation urn and memorabilia container, several objects and advantages of the present invention are:

a) to provide a colorfully designed memorial marker which can be produced in a variety of colors and designs for humans and pets;

b) to provide a cremation urn with the memorial marker that is large enough for all cremated ashes;

c) to provide a cremation urn with the memorial marker that is large enough for the cremated ashes of a husband and a wife;

d) to provide a memorabilia container with the memorial marker and cremation urn for special items of remembrance to be placed;

e) to provide a colorfully designed memorial marker with a cremation urn and memorabilia container that can be purchased not only in funeral homes and pet cemeteries, but in local retail stores;

f) to provide a colorfully designed memorial marker with a cremation urn and memorabilia container that can be used for cremated ashes or memorabilia items or both;

g) to provide a colorfully designed memorial marker with a cremation urn and memorabilia container that can be placed in a cemetery, at a gravesite, in a backyard, under a tree, beside a pond, or anywhere of the consumers choice;

h) to provide a colorfully designed memorial marker with a cremation urn and memorabilia container that can be purchased years after the death of the deceased individual or pet for special remembrance and healing in the mourning process;

i) to provide a colorfully designed memorial marker with a cremation urn and memorabilia container that is sealed and in the ground with the colorfully designed memorial marker flush with the ground, only exposing the colorfully designed memorial marker;

j) to provide pet owners instant access to memorial markers with a cremation urn and memorabilia container for their pet who was just euthanized and provide them with ample space for the pet's cremated ashes and memorabilia items, such as, the pet's collar, favorite toy, photograph's, etc.

k) to provide a place to safely secure the memorabilia items of the deceased so as to help individuals heal in the mourning process and prevent them from feeling the pain of guilt when having to discard the remembrance items in another way;

l) to provide a memorial marker that can be brightly colored, hold cremated ashes and memorabilia items;

m) to provide a place to safely secure the cremated ashes of humans or pets.

Further objects and advantages are to provide a memorial marker with a cremation urn and memorabilia container which can be used easily and conveniently to open and seal, which is simple to use and inexpensive to manufacture, which can be supplied in retail stores or funeral homes, or veterinarian's offices, and can be purchased as soon as the consumer is in need, especially under surprisingly unexpected adverse circumstances. Still further objects and advantages will become apparent from a consideration of the ensuing description and drawings.

### SUMMARY

The present invention relates to memorial markers that are colorful and offer multiple designs for the consumer to choose. A memorial marker in accordance with an exemplary embodiment of the present invention relatively includes a cremation urn and memorabilia container, urn and container assembly. The urn and the container assembly are one and the same as they hold the same embodiment. The cremation urn and memorabilia container assembly may include a container body having an internal chamber configured to receive and store cremated remains and articles of remembrance memorabilia. The cremation urn and memorabilia container are substantially the largest on the market, thereby allowing the cremation remains of a husband and wife, consisting of 622 cubic inches. A bottom cover with gasket assembly disposed on the bottom of the cremation urn and memorabilia container is a means to provide a safe and secure member to house cremated remains of humans and pets, further including memorabilia items. The present invention provides a unique memorial that emprises all three elements of the consumers needs, such as a colorfully designed marker, cremation urn and memorabilia container.

### DRAWINGS—FIGURES

FIG. 1 is a perspective view of the new memorial marker with a cremation urn and memorabilia container according to the present invention.

FIG. 2 is a side view of the cremation urn and memorabilia container and a front elevation view of the bottom cover.

FIG. 3 is a perspective view and a front view showing the bottom cover of said cremation urn and memorabilia container.

FIG. 4 is a cross section view of the memorial marker with a cremation urn and memorabilia container assembly including button head cap screw, further including self locking nut.

FIG. 5 is a front view of the bottom cover assembly including gasket.

### DRAWINGS—REFERENCE NUMERALS

10 Memorial Marker with a Cremation Urn and Memorabilia Container
12 Memorial Marker
14 Top Section of Cremation Urn and Memorabilia Container
16 Cremation Urn and Memorabilia Container
18 Rim
20 Gasket
22 Bottom Cover
24 Large button head cap screws
26 self-locking nuts

### DETAILED DESCRIPTION OF PREFERRED EMBODIMENT

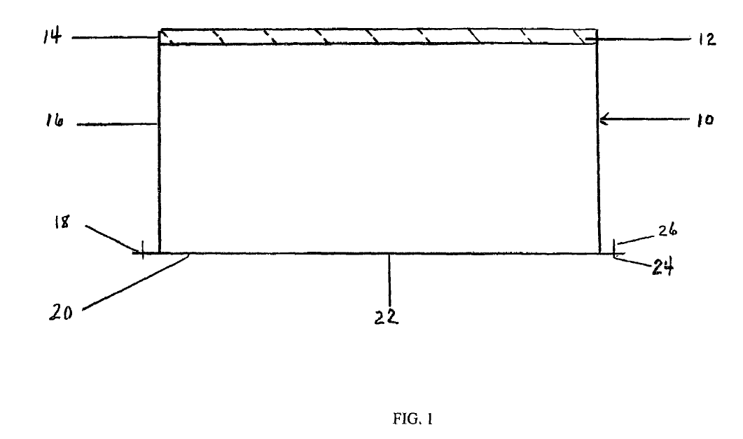

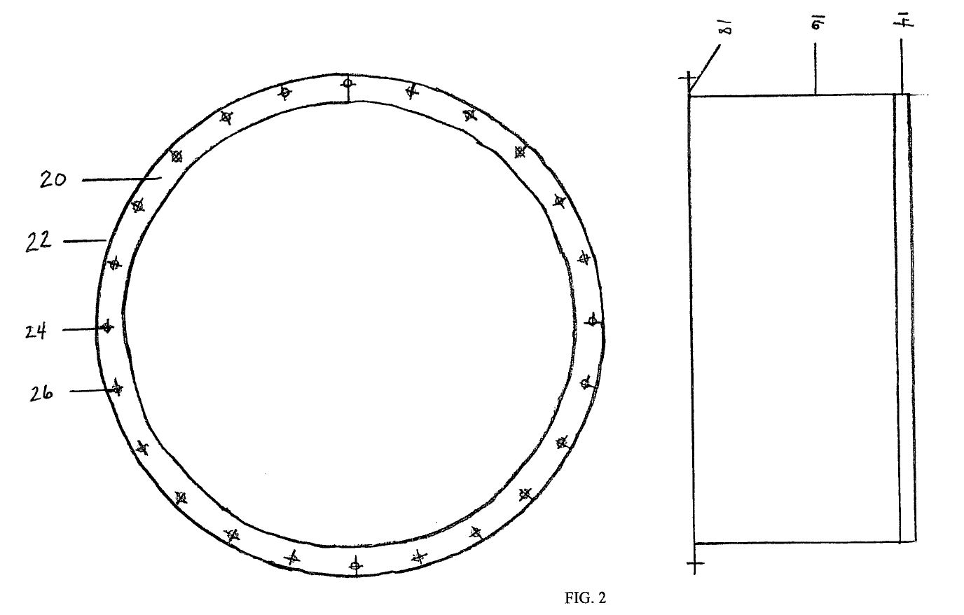

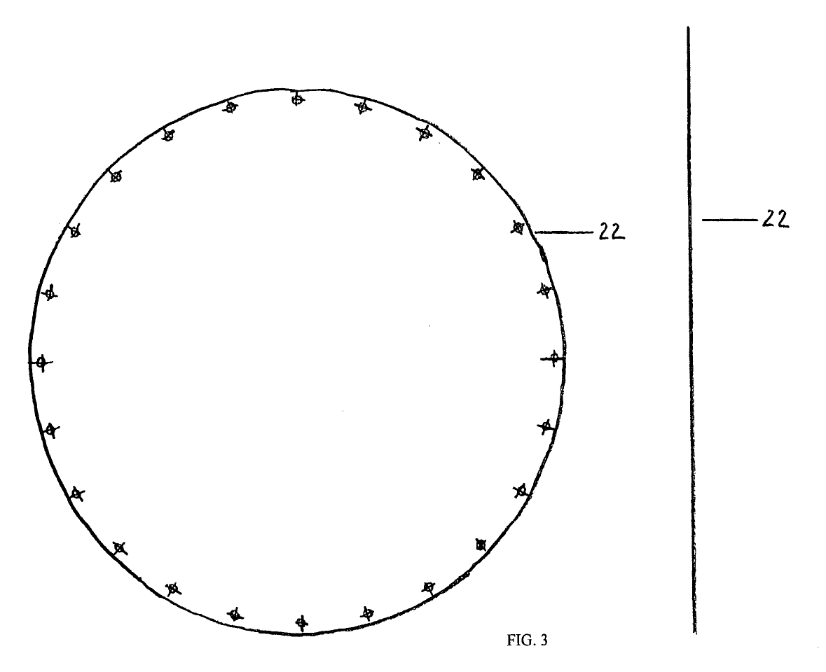

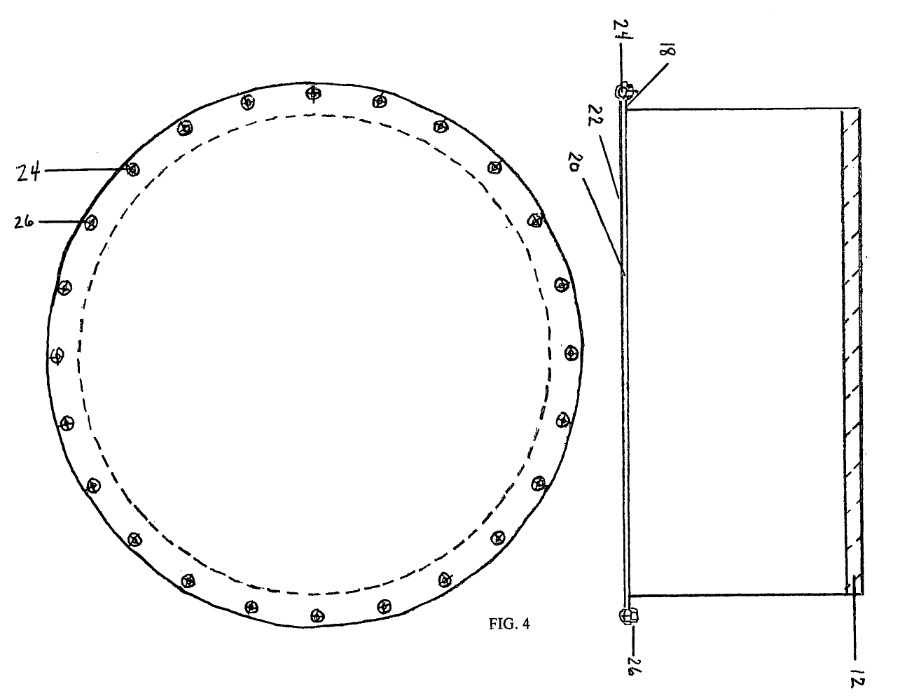

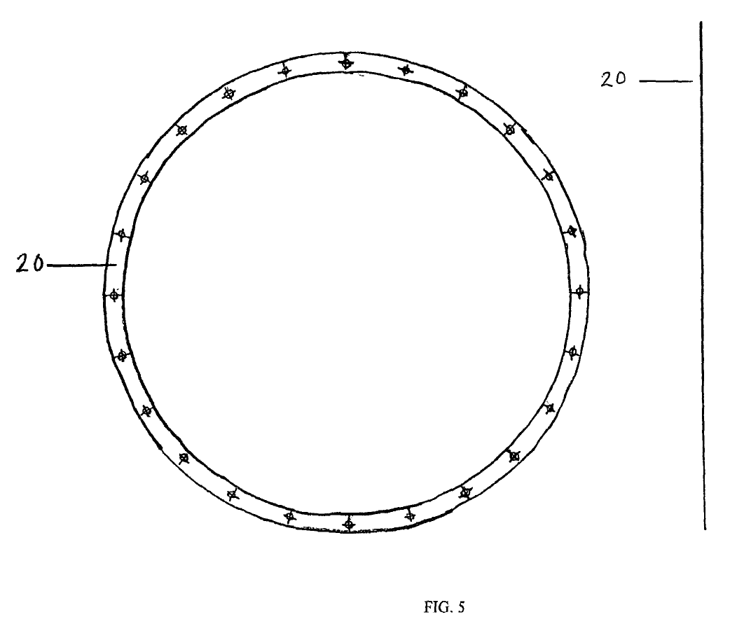

Referring now to the drawings, and particularly to FIG. 1 through 5 thereof, a new memorial marker with a cremation urn and memorabilia container embodying the principles and concepts of the present invention and generally designated by the reference numeral 10 will be described. As best illustrated in FIGS. 1 through 5, the memorial marker with a cremation urn and memorabilia container 10 generally comprises a device 10 for memorializing a human or animal with a decorative memorial marker and for preserving cremation remains of a human or animal and for holding and safely storing memorabilia items. The device 10 includes a memorial marker 12 having a general overall appearance of a circular decorative design selected from the group consisting of decorative concretes, marble, granite, or other materials which resist degradation, breakage or other damage after prolonged exposure to indoor, semi-outdoor, outdoor, underground or environmental conditions.

### Operation

The memorial marker 12 after being constructed of poured decorative concretes or cut marble or granite as selected from the group is placed in the top section 14 of the cremation urn and memorabilia container 16 thereof. The memorial marker 12 having been placed in said top section 14 having been sealed is flush with the ground after installation.

The cremation urn 16 being one and the same as the memorabilia container 16 having a general overall appearance of a cylinder or other shape selected by the group consisting of a hexagonal or octagonal shape.

The cremation urn 16 and memorabilia container 16 includes a rim 18 around the bottom perimeter of the opening.

The rim 18 is covered with the gasket 20 after applying a small stream of silicone to the rim 18 thereof. The gasket 20 is sealed by placing the bottom cover 22 over the gasket 20. The bottom cover 22 has the general appearance of a flat lid. The bottom cover 22 assembles by inserting button head cap screws 24 with self-locking nuts 26.

The bottom cover 22 assembly is capable of being removed from the rim 18 allowing the placement of cremation remains and memorabilia items within the cremation urn 16 and hence reinserted onto the rim 18 and reassembled by inserting button head cap screws 24 and self-locking nuts 26.

The rim 18 gasket 20 and bottom cover 22 all have a sequential number of holes drilled for assembly by inserting the button head cap screws 24 through the sequential holes and inserting the self-locking nuts 26 on top of said screws 24 to reseal the cremation urn 16 memorabilia container 16.

The device 10 being fully assembled with memorial marker 12 and said cremation remains and or memorabilia items hermetically sealed within cremation urn and memorabilia container 16 is placed in the ground with all of the device 10 being underground except for the top of the memorial marker 12 which is flush with the ground and visibly seen.

In a further aspect, a large plastic zip-locked freezer bag can be provided to hold the cremation remains which is adapted to be inserted into and received by the cremation urn 16. The large zip-locked freezer bag can be placed in a large velvet pouch with pull strings therein.

In a further aspect, a large velvet pouch with pull strings can be provided as a soft support which is adapted to receive the large zip-locked freezer bag of cremation remains. The large velvet pouch with pull strings is inserted into and received by the cremation urn 16.

A number of embodiments of the present invention have been described. Nevertheless, it will be understood that various modifications may be made without departing from the spirit and scope of the invention. Accordingly, other embodiments are within the scope of the following claims.

What is claimed is:

1. A memorial marker with a cremation urn and memorabilia container capable of holding the remains of a deceased human or animal and memorabilia type items, comprising, in combination: a decorative marker having a dimension for fitting into top section of said cremation urn and memorabilia container; a cremation urn capable of holding remains of a cremated human or animal therein; a memorabilia container being one and the same as the cremation urn capable of holding memorabilia items therein.

2. The memorial marker with a cremation urn and memorabilia container of claim 1 wherein said memorial marker is created with materials selected from the group consisting of decorative concretes, marble, granite or other materials which resist degradation, breakage or other damage after prolonged exposure to indoor, semi-outdoor, outdoor, underground or environmental conditions.

3. The memorial marker with a cremation urn and memorabilia container of claim 1 wherein said marker assembles on top of the cremation urn memorabilia container using a sealant conducive to environmental conditions.

4. The cremation urn memorabilia container in claim 1 comprising of a material selected by the group consisting of brass or galvanized steel or other materials capable of housing the cremated remains of a human or pet and housing memorabilia items.

5. The cremation urn memorabilia container in claim 4 further comprising of urn bottom cover.

6. The cremation urn memorabilia container in claim 4 further comprising of a gasket.

7. The cremation urn memorabilia container in claim 4 further comprising of button head cap screws.

8. The cremation urn memorabilia container in claim 4 further comprising of self locking nuts.
